(19) United States
(12) Patent Application Publication
(10) Pub. No.: US 2005/0004886 A1
(43) Pub. Date: Jan. 6, 2005

(54) Detection and reporting of computer viruses

(76) Inventors: Nathaniel Stahl, San Francisco, CA (US); Akmal Khan, Navato, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/841,959

(22) Filed: May 7, 2004

Related U.S. Application Data
(60) Provisional application No. 60/468,924, filed on May 7, 2003.
(60) Provisional application No. 60/468,778, filed on May 7, 2003.
(60) Provisional application No. 60/482,364, filed on Jun. 25, 2003.

(51) Int. Cl. G06F 7/00

(52) U.S. Cl. 707/1

(57) ABSTRACT

A system provides sharing of read-only file systems while at the same time providing each client of the read-only file system the ability to write to its own data store. Files can be either on a read-only persistent repository file system, or on a writeable persistent overlay file system. An “optimistic sharing” paradigm means that by default, everything on the file system is assumed to be read-only. If an attempt is made to modify a file—that is, a private copy is needed—the performance hit is typically minimal, because most written-to files are small. Even in the event of a larger file, the performance hit is a one-time cost. By intercepting attempts to write to files that should not be written to, viruses can be detected and alerts generated.

### CROSS REFERENCE TO RELATED APPLICATIONS

This application claims the benefit of U.S. Provisional Application Nos. 60/468,924, filed on May 7, 2003; 60/468,778, filed on May 7, 2003; and 60/482,364, filed on Jun. 25, 2003, each of which is incorporated by reference in its entirety

This application is also related to Application No. 10/______, entitled “Copy-On-Write Mapping File System”, filed on May 7, 2004, and which is incorporated by reference in its entirety.

### BACKGROUND OF THE INVENTION

1. Field of the Invention

The present invention relates generally to sharing storage devices among multiple computer systems. In particular, the present invention is directed towards a virtual file system that enables multiple computers to share read-only file systems while supporting copy-on-write operations.

2. Description of the Related Art

Many computer environments exist in which resources are shared between multiple computers. For example, consider a server computer that serves files over a network to a large number of client computers. Where a file is being served by a server to a remote PC, a separate copy of the file must often be maintained on the server for each computer accessing the file if the computer expects to have a separate copy, so that the file can be written to as necessary by the accessing computer. For example, if the user environment for a PC accessing a server is configured according to a default configuration file on that server, then two PCs wishing to change their environments after login must each have their own copy of the environment file stored on the server.

It is also possible to attach a physical storage device to multiple machines, for example through the use of a Storage Area Network (SAN). However, this is also problematic. Consider a situation in which a single hard drive is being shared by multiple computers, each computer having block-by-block access to the hard drive. Each user's computer has a notion of what the file system (i.e. the blocks on the hard drive) looks like. For example, suppose that the file system has directories a, b, and c. A first user decides to create directory d, and a second user decides to create directory e. Thus, each user is modifying the block that contains the root directory, in this example. If the first user writes to the disk first, and then the second user writes to the disk, the second user, having no idea that the first user just wrote to the disk, will simply write over the changes that the first user made, and the file system will have directory e, but not directory d. In addition, the computers are caching not just at a data level, but also at a semantic level. For example, if a computer tries to open a file that does not exist, the computer might cache the fact that the file does not exist. Meanwhile, the file is created by another computer. However, the next time the first computer attempts to access the file, since it is using a cache of the semantics of the file system, the computer will not attempt to look for the file, but will instead report the incorrect data from the cache, which in this instance is that the file does not exist.

One way of sharing directories in the Unix environment has been through the use of the Network File System (NFS). NFS allows a computer to mount a partition from a remote computer on the local computer in order to share directories. A similar program, Samba, exists for users of Windows-based systems. NFS and Samba allow multiple computers to share write access to directories. Additionally, they allow remote computers to have access to files on a physical storage device without requiring direct access, by allowing the NFS or Samba server to access the storage on their behalf.

Another attempt to solve this problem has been through the use of clustered file systems such as CXFS, VxFS, and Lustre. Clustered file systems are aware that their block devices are shared, and include synchronization mechanisms and semantic locking. When a file is created, for example, the information is made known to other computers sharing access. Synchronization is carried out at both the data layer and the semantic layer. However, NFS and clustered file systems only allow sharing at the directory level or entire file system level, respectively, not at the file level. Further, they do not protect against one computer writing over data that another computer might need, or one computer corrupting data because of a virus or malicious code/users.

Thus, there is substantial difficulty in enabling multiple computers to share access to a physical storage device such as a hard drive while still allowing files that need to be written to be written. Typically, sharing is only enabled down to the directory level, and not to the file level. This means that either a whole directory must be shared, or the whole directory must be private if it will be written to. If one of the computers sharing the drive wants to modify a file in a shared directory on the device for its own use, then a private copy of the entire folder containing the file must be made for that computer. For a large directory, this results in significant wasted storage. This problem grows worse every time a new file from a previously read-only directory needs to be written.

Even if the above problems could be successfully avoided, additional problems remain to be solved. For example, if one computer is infected by a virus, the virus can spread to the writeable shared device, and then infect all other systems sharing the device. Additionally, where each computer needs to access a file with a specific name, e.g., in the case of a configuration file, the file cannot be stored on a write-shared disk, as it will likely be corrupted by another computer trying to modify it for its own use.

Some IT professionals have tried to use existing technology to share some directories but not others, to save storage and efficiently create new servers. If a separate copy of all data is required for every new server created, a bottleneck quickly forms, because copying all the data for the server typically takes a long time. In addition, much more storage is needed at added expense, and that storage will be accessed less efficiently because cache utilization will be much lower than it would have been had much more of the data been shared. Instead, an attempt has been made to share data instead of copying it. This requires determining where each application writes its data in order to decide which directories can be shared as read-only; it is a question of which files get written where and under what circumstances. In reality, many typical applications do not even document where they write files. System engineers can try to find it out by inspecting the program at run time to find out which files are being touched, but this is not a reliable method—for example, a file might be written to only rarely, and not caught during inspection. What is worse, if an update is released for the software in question, the inspection analysis has to be re-done. This very fragile way of sharing has resulted in the practice of copying all files to new servers, defeating the original attempt to save both time and cost.

An additional problem with sharing files among multiple computers involves performing upgrades. If some users wish to upgrade while others do not, then a problem is created because each user is using a shared version of the software, and an upgrade either takes place for everyone or no one. One solution is to keep different versions of the software in question on different partitions. However, this requires additional space and administrative overhead. Each computer must then be configured to use either the new partition or the old partition. Accordingly, it is difficult to upgrade anything less than all systems at a time.

Accordingly, there is a need for an efficient method of sharing storage across multiple servers.

### SUMMARY OF THE INVENTION

The present invention enables “semi-sharing” of data. In general, this semi-sharing has application to environments in which a large volume of information is shared among many computer systems, but each computer system has a need to modify some portion of the data.

In one embodiment, the present invention enables sharing of read-only file systems while at the same time providing each client of the read-only file system, e.g., a workstation, the ability to write to its own data store. Files can be either on a read-only persistent repository file system, or on a writeable persistent overlay file system. The present invention's “optimistic sharing” paradigm means that by default, everything on the file system is assumed to be read-only. If an attempt is made to modify a file—that is, a private copy is needed—the performance hit is typically minimal, because most written to files are small. Even in the event of a larger file, the performance hit is a one-time cost.

In a system architecture contemplated by the present invention, one or more read-only persistent repository file systems are shared amongst many computers. Each computer has access to a writeable overlay file system. When an application executing on a computer attempts to write data to a file located on the read-only file system, the file is instead written to the overlay file system. Subsequent file operations on the file are directed towards the overlay file system instead of to the read-only file system. A mapping is maintained between filenames and their path locations, making the process transparent to the calling application. This eliminates the need for duplicate storage, thus saving money and improving performance of SAN and NAS devices by allowing more efficient use of disk caches. In addition, new servers can be deployed rapidly in response to changing load conditions, software updates, and the like.

### BRIEF DESCRIPTION OF THE DRAWINGS

FIG. 1 is a block diagram illustrating a network architecture in accordance with an embodiment of the present invention.

FIG. 2 is a block diagram illustrating an overview of a system architecture in accordance with an embodiment of the present invention.

FIG. 3 is a flow chart illustrating flow of data during a lookup operation in accordance with an embodiment of the present invention.

FIG. 4 is a flow chart illustrating flow of data during a copy-on-write operation in accordance with an embodiment of the present invention.

FIG. 5 is a block diagram illustrating a map file system in accordance with an embodiment of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

System Architecture

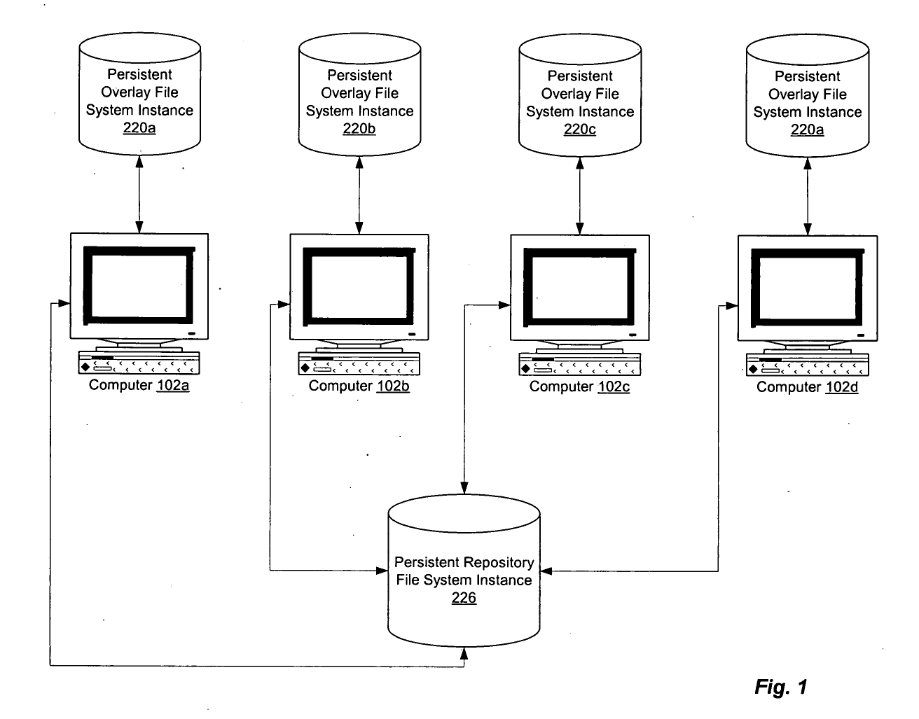

FIG. 1 illustrates conceptually a network architecture designed to take advantage of the present invention. FIG. 1 includes a number of computers 102, each computer preferably including an instance of the Map File System as described below, and in communication with an instance of a read-only persistent repository file system 226. Each computer 102 also has read and write access to a persistent overlay file system 220. Thus, in a manner such as that described below, computers 102 can share a common read-only file store 226 while at the same time writing data as necessary to an overlay 220. Note that FIG. 1 illustrates only one of a variety of different ways of configuring a network using the described system. For example, repository file system 226 could be one or several physical drives. Similarly, overlay file system 220 may be one drive with multiple partitions and accessed by more than one computer 102, or may be one drive for each computer 102. As those of skill in the art will appreciate, the physical configuration can be any in which shared read-only access is given to the repository file system instance, and unshared write access is given to an overlay file system instance.

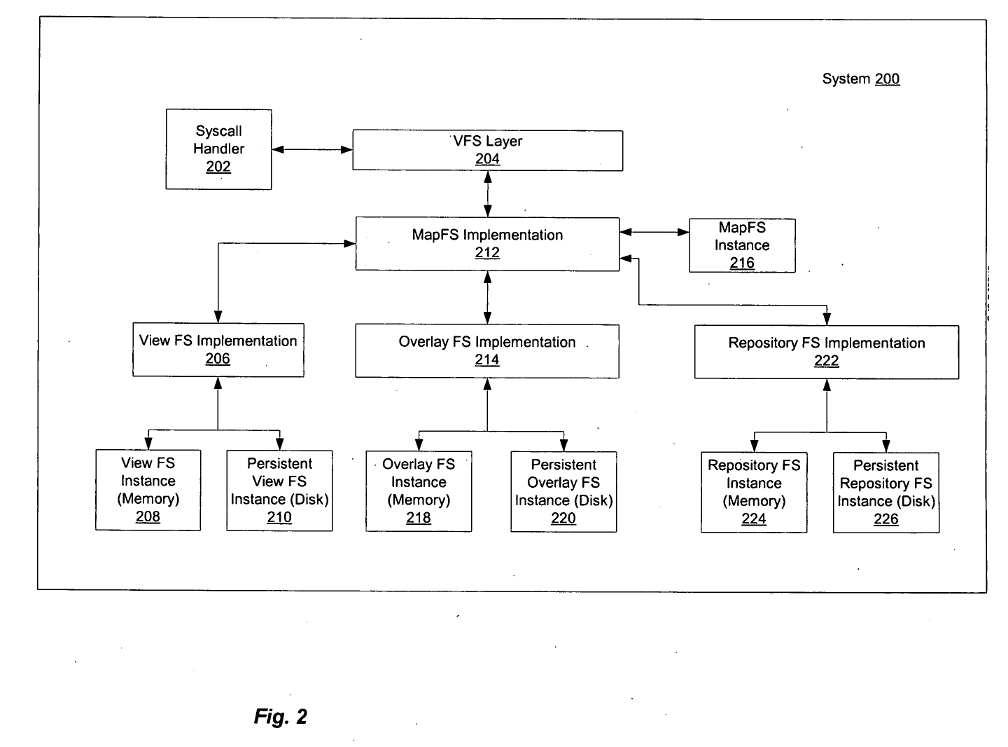

FIG. 2 provides an overview of a preferred embodiment of a system 200 including a Map file system (MapFS) implementation 212. Syscall handler 202 is a conventional part of an operating system such as Linux, which receives and handles system calls from applications. For system calls that require interaction with an underlying file system, syscall handler 202 passes the request to a virtual file system layer (VFS layer) 204. VFS layer 204 is a conventional virtual file system layer such as one implemented by the Linux operating system. VFS layer 204 is an abstract layer designed to enable the upper layers of a system kernel to interact with different file systems. For example, the Linux VFS supports ext3, FAT and NFS file systems, as well as various others. The VFS layer allows programs to have a standard set of interfaces for managing files; allows the operating system and file system implementations to have a standard way of communicating with each other; and implements a library of common file system-related functions that file system implementations can use to avoid code duplication.

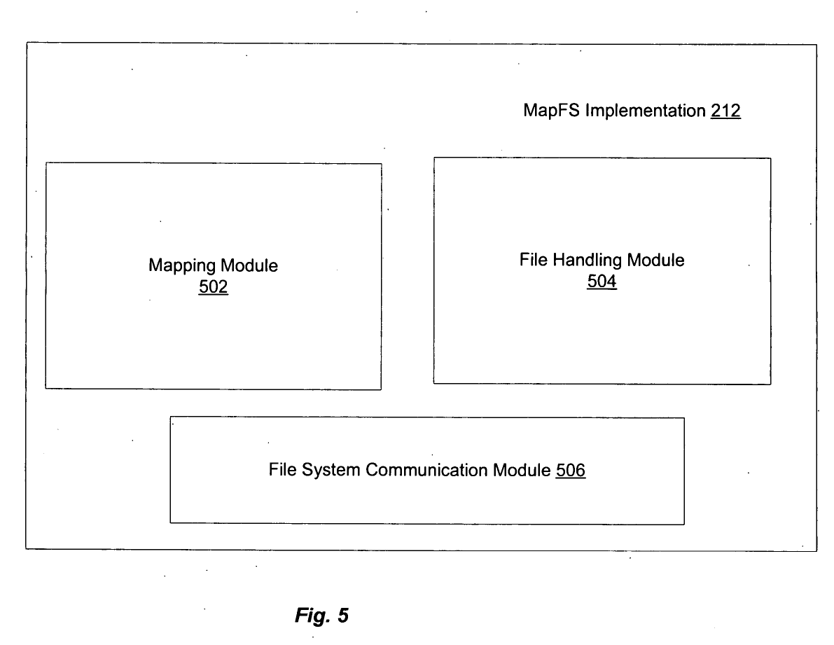

VFS Layer 204 is also in communication with MapFS Implementation 212. MapFS is a host file system that implements the interface expected by the VFS layer 204, with functionality described below. MapFS Implementation 212 presents an interface to the VFS Layer 204 that conforms to the VFS requirements of the particular operating system in use, e.g., Linux. The operation of MapFS Implementation 212 is further described below with respect to FIG. 5. A particular instance of a MapFS file system is MapFS Instance 216. The MapFS Instance 216 stores transient information for the MapFS file system as composed of information about the underlying view, repository and overlay file systems. In receiving requests from applications (via the VFS layer), passing the requests to repository and overlay file systems as appropriate, and satisfying the requests by returning a result to the application, MapFS provides the illusion to the requesting application that there is one coherent writeable file system.

Repository FS Implementation 222 is an implementation of a file system responsible for maintaining data on the persistent read-only file system 226 that is to have its data shared. Repository FS Implementation 222 receives and responds to file system requests from MapFS Implementation 212. Repository FS Instance in memory 224 represents a transient in-memory status of a particular Repository file system in persistent storage. Status includes, for example, information about what files exist (or do not) and have been successfully or unsuccessfully looked up, file size, permission data, actual cached data blocks, etc.

Overlay FS Implementation 214 is an implementation of a file system responsible for providing writeable storage on the persistent overlay file system instance 220. Overlay FS Implementation 214 receives and responds to file system requests—including write requests—from MapFS Implementation 212. Overlay FS Instance in memory 218 behaves analogously to Repository FS Instance 224. In a preferred embodiment, the Overlay FS is a directory tree rooted at a location specified when the MapFS is instantiated.

ViewFS Implementation 206 maintains a mapping between file names as referenced by MapFS Implementation 212 and as stored by the overlay and/or repository file systems. Persistent View FS Instance 210 maintains a physical (i.e. disk) record of the mappings, while ViewFS Instance 208 maintains information in memory similar to Repository FS Instance 224 and Overlay Instance 218. In a preferred embodiment, the View FS is a directory tree rooted at a location specified when the MapFS is instantiated.

In general, file requests received through VFS Layer 204 by MapFS Implementation 212 are satisfied by accessing a repository version of the file or by accessing an overlay version of the file. The view specifies which host file should be used to satisfy requests on the file. If the file is on a repository and an attempt is made to modify it, the file is migrated to the overlay. The following examples are illustrative.

FIG. 5 illustrates logical subunits that perform functionality of the MapFS Implementation 212 in one embodiment. MapFS Implementation 212 includes a mapping module 502, a file handling module 504 and a file system communication module 506. File system communication module 506 presents an interface for communicating with other file system implementations such as View FS implementation 206 and Repository FS implementation 222. Mapping module 502 provides mapping functionality for MapFS Implementation 212, including logic used to obtain locations of files or data structures within system 200. File handling module 504 provides an interface for receiving and responding to requests from VFS layer 204 and additionally includes logic used to perform file system operations.

Data Flow

In a Linux environment, a module is preferably loaded that describes the MapFS's name and how to instantiate it. When the module is loaded it calls a function to register a new file system, passing the name of the file system, and a procedure to use for initializing a new superblock when the Linux “mount” operation is called with that file system name. Those of skill in the art will appreciate that this technique for loading a file system via a module is conventionally known.

To instantiate the MapFS implementation 212, the instantiation procedure specified when the module was loaded is called with arguments including a location of the view and the overlay. The mount point for MapFS is specified by the entity instantiating MapFS. Another argument specifies the lookup root, which is a point in the tree of file systems mounted on the relative path from which to look up files referenced by the view. Once MapFS has been initiated, it can be acted upon using conventional system calls, which are handled as described below.

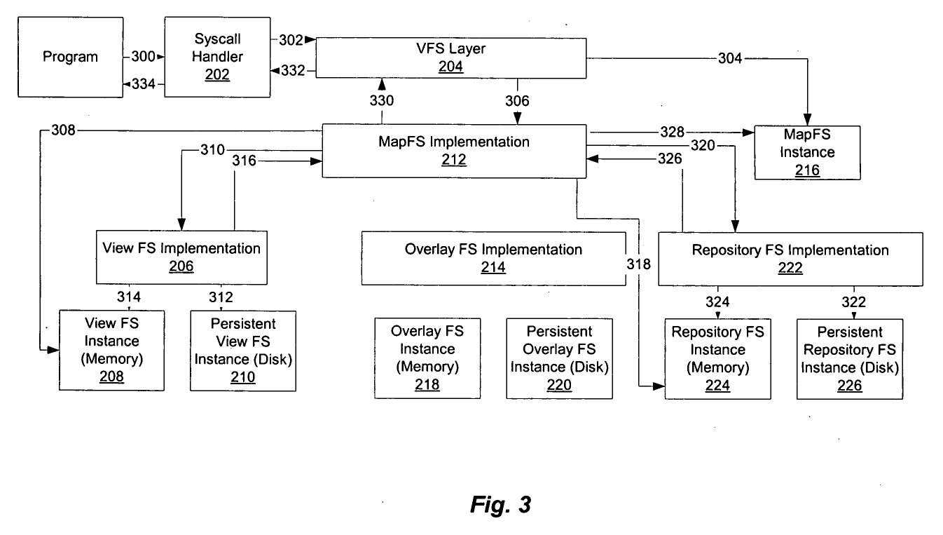

Referring now to FIG. 3, there is shown a data flow diagram illustrating a lookup of a file located on persistent repository 226. Initially, a lookup begins when the syscall handler 202 receives 300 a lookup syscall from an application. The syscall handler 202 then calls 302 into the VFS layer 204. The VFS layer 204 then examines 304 the publicly accessible part of the MapFS instance 216 to see if the MapFS instance 216 has information about the filename being looked up. In one embodiment, when the VFS layer 204 examines the MapFS instance 216 data, it searches a table of names that have already been looked up and the results of those lookups. If the file exists, then the result of the lookup is a reference to the MapFS inode. If the file does not exist, but has been previously looked up, then the result of the lookup is a negative entry that indicates the file does not exist. Since in this example this is the first time the pathname has been resolved, the MapFS instance 216 will not have information about the filename. Accordingly, the VFS layer 204 then calls 306 into the MapFS implementation 212 to look up the pathname. The VFS layer 204 hands file handling module 504 a handle to the MapFS parent directory, and the name in that directory to be looked up. The MapFS Implementation 212 preferably looks up the name, inserts an entry for the name into its table of recently looked up names, and returns a handle to that entry upon completion of the lookup request.

The mapping module 502 looks 308 in the View FS instance 208 (via file system communication module 506) to see whether the file is cached. Preferably, the view caches filenames in a manner similar to MapFS—that is, in a table of names and look-up results. Again, since this is the first time the file is being looked up, it will not exist in the View's cache either, unless it has been looked up through some non-MapFS process. Thus, the mapping module 502 asks the 310 View FS implementation 206 to look up the name in the View in a manner preferably similar to the way in which the VFS layer examines MapFS instance data described above. The View FS Implementation 206 looks up 312 the file in the persistent view FS instance on disk 210 and updates 314 the View FS instance in memory 208 by populating an in-memory description of the file, and inserting an entry in its name-to-inode table. The View FS implementation 206 returns 316 a reference to the file in the View FS Instance 208 to the mapping module 502.

Note that at this point in the data flow, a series of steps similar to steps 310 to 316 are repeated to read the contents of the file in the View to find the host file path. However, for clarity the repeated steps are not illustrated in FIG. 3. In the case of a normal file, the data in a file stored by the view implementation is the absolute path to that file; for a directory or basic file (a non-data, non-directory file such as block and character special files, symlinks, named pipes, etc.), there is no host component—the view component is a directory or non-data file, and the characteristics of that file are used rather than redirecting.

Next, the mapping module 502 examines 318 the Repository FS Instance 224 to determine whether the file referenced by the View component is already known to the Repository FS 224. Since this is the first time the file is being looked up, it will not be known to the Repository FS 224, unless due to some non-MapFS process. Next, the mapping module 502 asks the Repository FS Implementation 222 to look up the pathname it previously retrieved from the View. Repository FS Implementation 222 looks up 322 the data from the Persistent Repository FS Instance 226, and updates 324 the Repository FS Instance in memory 224. The Repository FS Implementation 222 then returns 326 the result to the MapFS Implementation 212 with a MapFS file which references the information looked up from the View and Repository. Finally, file handling module 504 returns 330 a handle to the table entry to the VFS layer 204, which returns 332 the handle to the syscall handler 202, which in turn returns 334 the handle to the program. Note that the handle to the table entry is a handle to a MapFS object that internally references the view and host files, if the file is a regular file, and internally references only a view, if the object is a directory or basic file.

A syscall received by MapFS implementation 212 via VFS layer 204 might also be a create operation, which is a request to create a file of specified name. For example, VFS layer 204 might receive a request to create the file “/foo/bar/baz”. VFS layer 204 will perform a lookup operation using MapFS implementation 212 as described above, and will fail when it attempts to locate a file named “baz” on “/foo/bar/”. Next, VFS layer 204 asks file handling module 504 to create “baz” on “/foo/bar/”. File handling module 504 receives from the VFS layer 204 a handle to the MapFS parent directory and the filename to be created, “baz”. Mapping module 502 then requests that the View FS implementation 206 create a file with the name “baz” in the view directory “foo/bar”. The View FS implementation 206 updates the persistent View FS instance 210 and the View FS instance in memory 208 and returns a handle to the new file to MapFS implementation 212. Mapping module 502 then examines the file it was handed back and sends a write request to the View FS implementation 206 to populate the view file with a path to the file it is about to create on the overlay. It forms that path by looking at the inode number of the file that the view handed it. File handling module 504 sends (again, via file system communication module 506) a create request to Overlay FS implementation 214 with the name of the inode number of the view file. The Overlay FS implementation 214 then creates that file in the persistent Overlay FS instance 220, update the Overlay FS instance in memory 218 and returns a handle to the file to file system communication module 506. MapFS implementation 212 constructs a MapFS file object that references the view and overlay components, inserts the object into the MapFS instance 216, and returns a handle to that new file to VFS layer 204, which in turn passes the handle to the requesting program. Those of skill in the art will appreciate that the naming scheme described for naming overlay files is one of many possible schemes that could be used.

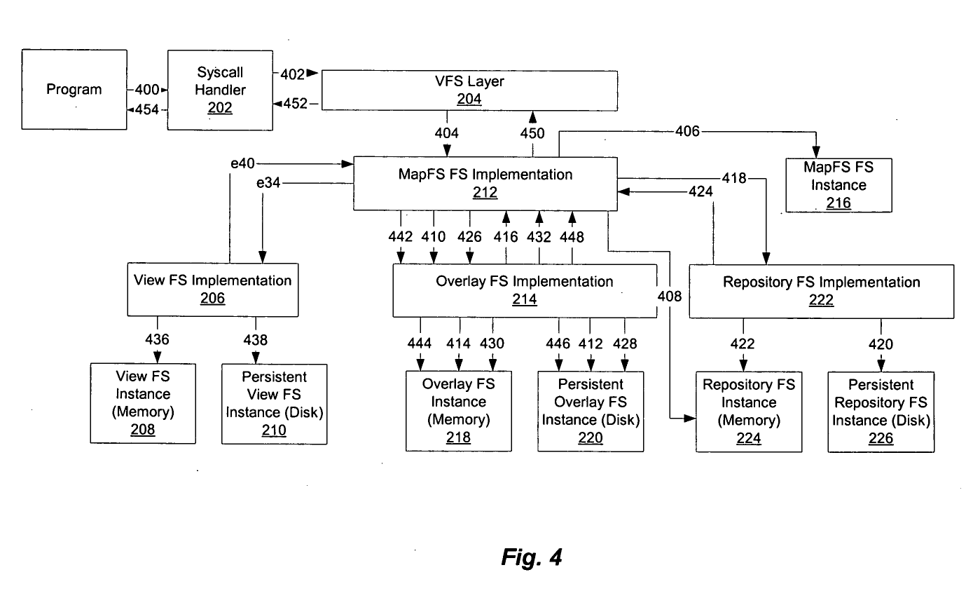

Referring now to FIG. 4, there is shown a diagram illustrating the flow of data when a program attempts to write a file whose host component currently resides on a persistent Repository Instance 226.

First, syscall handler 202 receives 400 a write call from a program and passes 402 the write call through to the VFS Layer 204. The VFS layer 204 then passes 404 the call through to the file handling module 504. MapFS Implementation 212 examines 406 its private data for the file in the MapFS Instance 216 to determine the current location of the host component file. The MapFS Instance 216 preferably includes a handle to an inode of the host file. Since, in this example, the file resides on the repository file system, the MapFS Instance will have a handle to the inode residing on the repository instance. Next, the file handling module 504 looks 408 at the public part of the host file in the Repository FS instance 224 and notes that its file system (the Repository) is mounted read/only, and that the MapFS Implementation 212 will need to perform a copy-on-write to the Overlay file system. The file handing module 504 then calls 410 into the Overlay Implementation 214 to create a new file.

Overlay Implementation 214 creates 412 the new file in the persistent overlay instance 220 and updates 414 the overlay instance 218 in memory with information about the newly-allocated in-memory inode, which includes information about the file created on disk. Overlay Implementation 214 additionally fills an entry in the name-to-inode mapping table for the newly-created file. The Overlay Implementation 214 then returns 416 a handle to the new file to the MapFS Implementation 212. MapFS Implementation 212 then sends 418 a request to read the contents of the current host file to the Repository FS Implementation 222.

Repository FS Implementation 222 reads 420 the contents of the file from the persistent repository FS instance on disk 226 and updates 422 the copy in memory, returning 424 the contents of the file to the MapFS Implementation 212. File handling module 504 writes 426 the data to the new file on the overlay by sending a write request to the Overlay FS Implementation 214. The Overlay FS Implementation 214 writes 428 the data to the Persistent Overlay FS Instance 226 and updates 430 the data cache in the Overlay FS instance in memory 218, returning 432 a success code to the MapFS Implementation 212.

Next, mapping module 502 sends 434 a write command to the ViewFS Implementation 208 to update the location of the host component of the MapFS file from the Repository file system to the Overlay. The View FS Implementation updates 436 the View FS Instance in memory 208 and 438 the Persistent View FS Instance 210, and acknowledges 440 to the MapFS Implementation 212 that there were no errors.

Note that if any processes have the file mapped directly into their memory, synchronization with the virtual memory subsystem preferably occurs at this point in the data flow.

The file handling module 504 then sends 442 the original write request through to be satisfied by the Overlay FS Implementation 214. The Overlay FS Implementation 214 updates 444 the Overlay FS Instance in memory 218 and updates the Persistent Overlay Instance on disk 220. Then the Overlay FS Implementation returns 448 the results of the write operation to the MapFS Implementation 212.

Finally, the file handling module 504 returns 450 the results of the write to the VFS Layer 204, which returns 452 the results of the write to the sycall handler 202 to be returned 454 to the program that originally requested it.

In one embodiment, if the persistent overlay file system instance on disk 220 approaches its capacity, a new overlay can be allocated and added to the file system dynamically. MapFS then sends write requests to the new overlay. Because MapFS transparently handles translating requests from the MapFS file object to the host file object, any change in the host file is completely transparent to the application generating the requests. In this manner, the MapFS implementation 212 insures continuity of memory accesses.

Virus Detection and Reporting

Certain observations can be made about typical usage patterns in an environment where multiple computers are sharing read-only storage devices and have private access to overlays. In practice, executable files should not typically be modified, since they typically contained compiled code. Conversely, modification of data files is not inherently suspicious behavior.

As described above, when MapFS implementation 212 determines that a program is trying to modify a read-only file on persistent Repository FS instance 226, file handling module 504 initiates the creation of a copy of the file through the Overlay FS implementation 214 and uses mapping module 502 and the View FS implementation 206 to create an indirection mapping from the file name to the location of the writeable copy on the overlay.

Since every initial write to a file on the overlay creates a copy of the file and a mapping in the view, the copies and mappings serve as a record of all the write requests made by programs running on the computer. In a preferred embodiment, file handling module 504 analyzes the record of the write requests to detect writes to executable files or other abnormal behavior that might indicate the presence of a virus in a managed instance.

For example, in normal operation a program running on a computer 102 will not write to an executable file. If a computer 102 does write to an executable file, then this behavior might indicate that the computer 102 is executing a computer virus that has modified the executable file in order to infect it or cause other damage. In addition to executable files, other files may be of a type that should not be written to under normal circumstances. In a preferred embodiment, MapFS implementation 212 maintains a record of file types that should not be written to. In an alternative embodiment, MapFS implementation 212 maintains a list of specific files that should not be written to.

In one embodiment, file handling module 504 monitors the write requests received from VFS layer 204. If a write request is to an executable file or another file that should not be modified, file handling module 504 raises an alert or triggers another function to indicate abnormal behavior. In another embodiment, file handling module 504 periodically checks the files on the Overlay FS implementation 214 and the mappings in the View FS implementation 206 for executable files or other files that should not be modified in order to identify viruses or other abnormal behavior.

The present invention has been described in particular detail with respect to a limited number of embodiments. Those of skill in the art will appreciate that the invention may additionally be practiced in other embodiments. For example, the indirection mapping functionality of ViewFS implementation 206 can be provided in other embodiments by a database, or more generally, by any data structure capable of supporting an indirection mapping.

The present invention also has a number of applications beyond the semi-sharing of data in a LAN environment. In general, the present invention lends itself to any application in which most—but not all—data being supplied is shared data, i.e. data that is common to the recipients. For example, in one embodiment the present invention can be used to provide portal technology in which almost all content seen by users is invariant, but a small portion of the content is modifiable on a per-user basis. The indirection mapping performed by the View in such a case is not from one file to another, but from one web page to another. In such embodiments, the logic of MapFS Implementation 212 can be described more generally as a data mapping module.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of MapFS implementation 212 and so forth may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A computer-implemented method for detecting viruses in a shared read-only file system, the method comprising:
receiving a request from a virtual file system (VFS) layer, the request including a file identifier and an operation to be performed on the identified file;
determining whether the identified file is located on a read-only file system;
responsive to the identified file being located on a read-only file system:
determining that the identified file is of a type that should not be written;
generating an alarm, the alarm including indicia of the file.

2. The computer-implemented method of claim 1 wherein the file type is an executable file type.

3. A computer-implemented method for detecting viruses in a shared read-only file system, the method comprising:
receiving a request to write to a file;
determining that the file is located on a read-only data store;
determining whether the file is of a type that should be written;
responsive to the file not being of the type that that should be written, generating a virus warning alarm; and
responsive to the file being of type that should be written:
automatically copying the file to a writeable file system; and
writing to the copy of the file.

4. The computer-implemented method of claim 3 wherein the file type that should not be written is an executable file type.

5. A computer-implemented method for detecting viruses in a shared read-only file system, the method comprising:
receiving a plurality of write requests, each write request identifying a file to be written;
determining that the files are located on a read-only storage device;
copying the files to a writeable storage device;
creating a mapping from each file to the copy of the file;
determining whether one of the copied files is of a type that should not be written; and
responsive to one of the copied files being of a type that should not be written, generating a virus warning alarm.

6. The computer-implemented method of claim 5 wherein the file types that should not be written include an executable file.

7. A system for detecting viruses in a shared read-only file system, the system comprising:
a file handling module for receiving from a file system a file identifier and an operation to be performed on the identified file;
a mapping module, communicatively coupled to the file handling module, for determining a mapping between the file identifier and a location of a file identified by the identifier;
a file system communication module, communicatively coupled to the mapping module, for:
determining whether the file is of a type that should not be written;
responsive to the file being of the type that should not be written, generating a virus warning alarm; and
responsive to the file not being of the type that should not be written, performing the operation on the identified file.

8. The system of claim 7 wherein the file types that should not be written includes an executable file.

9. A computer program product for detecting viruses in a shared read-only file system, the computer program product stored on a computer-readable medium and including code configured to cause a processor to carry out the steps of:
receiving a request to write to a file;
determining that the file is located on a read-only data store;
determining whether the file is of a type that should be written;
responsive to the file not being of the type that that should be written, generating a virus warning alarm; and
responsive to the file being of type that should be written:
automatically copying the file to a writeable file system; and
writing to the copy of the file.

10. The computer-implemented method of claim 9 wherein the file types that should not be written include an executable file.
